(19) United States
(12) Patent Application Publication
(10) Pub. No.: US 2016/0245951 A1
(43) Pub. Date: Aug. 25, 2016

(54) Method for Parameterizing a 3D Domain With Discontinuities

(71) Applicants: Elena Kartasheva, Alpharetta, GA (US); Valeriy Kubyak, Alpharetta, GA (US); Valeriy Shmyrov, Alpharetta, GA (US); Dmitry B. Kandybor, Alpharetta, GA (US); Anastasia Lomokhova, Alpharetta, GA (US)

(72) Inventors: Elena Kartasheva, Alpharetta, GA (US); Valeriy Kubyak, Alpharetta, GA (US); Valeriy Shmyrov, Alpharetta, GA (US); Dmitry B. Kandybor, Alpharetta, GA (US); Anastasia Lomokhova, Alpharetta, GA (US)

(21) Appl. No.: 15/009,946

(22) Filed: Jan. 29, 2016

Related U.S. Application Data
(60) Provisional application No. 62/120,653, filed on Feb. 25, 2015.

(51) Int. Cl. G01V 99/00

(52) U.S. Cl. CPC G01V 99/005

(57) ABSTRACT

A method of generating a volumetric data structure of a subsurface region, including: obtaining, with a computer, a volume segment of the subsurface region, wherein the volume segment is bounded by a first horizon and a second horizon, and by a plurality of lateral surfaces formed by faults and boundaries of a geological model corresponding to the subsurface region; obtaining, with the computer, an isomorphic triangulation of the first horizon of the volume segment; deforming, with the computer, the isomorphic triangulation of the first horizon of the volume segment to fit a boundary of the second horizon of the volume segment; after the deforming, creating, with the computer, a template grid from the first horizon of the volume segment and the second horizon of the volume segment; generating, with the computer, layer sections from the template grid by cutting the template grid by lateral surfaces of the volume segment; and generating, with the computer, the volumetric data structure of the subsurface reservoir as a prismatic grid from isomorphic triangulations of the layer sections.

### CROSS-REFERENCE TO RELATED APPLICATION

This application claims the benefit of U.S. Provisional Patent Application 62/120,653 filed Feb. 25, 2015 entitled METHOD FOR PARAMETERIZING A 3D DOMAIN WITH DISCONTINUITIES, the entirety of which is incorporated by reference herein.

### FIELD OF THE INVENTION

Exemplary embodiments described herein pertain to the field of oil and gas exploration, and more specifically to the generation of a grid of a subsurface reservoir for modeling or simulation.

### BACKGROUND

This section is intended to introduce various aspects of the art, which may be associated with exemplary embodiments of the present invention. This discussion is believed to assist in providing a framework to facilitate a better understanding of particular aspects of the present invention. Accordingly, it should be understood that this section should be read in this light, and not necessarily as admissions of prior art.

Basin modelling reconstructs the geological history of a sedimentary basin and its petroleum systems in order to help locate hydrocarbon traps, that is the reservoirs, to assess the amount and quality of the trapped hydrocarbons, and finally to assess the risks of encountering excess pressures while drilling. Reservoir simulation studies the evolution over time of the proportions of water, gas and petroleum in the reservoir so as to appreciate the cost-effectiveness, to validate or to optimize the position of the wells providing smooth operation of the reservoir development.

Three-dimensional (3D) model construction and visualization commonly employs data stored as a structured grid or an unstructured grid. Such model construction and visualization have been widely accepted by numerous disciplines as a mechanism for analyzing, communicating, and comprehending complex 3D relationships. Examples of physical regions that can be subjected to 3D analysis include the earth's subsurface, facility designs and the human body.

The ability to extract useful information from a complex data model and to display that information is desirable in many fields, including the fields of hydrocarbon exploration and production. Prior techniques include building corner-point pillar grids (Petrel®) and, more recently, building hex-dominant meshes (U.S. Patent Publications 2011/0015910 and 2012/0026167, the entire contents of both of which are hereby incorporated by reference in their entirety). However, these conventional approaches require that the parameterization be tied to a structured grid (pillar grid) or into a hex-dominant mesh. Structured or hex-dominant meshes have limitations in their ability to characterize a complex geometric shape. Thus, their application may sacrifice accuracy of representation or result in invalid or bad quality meshes. Since those meshes are used as a basis (parameterization) for the subsurface reservoir modeling process and their bad quality introduces deficiencies in the modeling process and resulting model. As explained in greater detail below, the present technological advancement can use a triangular mesh of flexible pillars that provides great flexibility in handling complex geometries without loss of mesh quality.

### SUMMARY

A method of generating a volumetric data structure of a subsurface region, including: obtaining, with a computer, a volume segment of the subsurface region, wherein the volume segment is bounded by a first horizon and a second horizon, and by a plurality of lateral surfaces formed by faults and boundaries of a geological model corresponding to the subsurface region; obtaining, with the computer, an isomorphic triangulation of the first horizon of the volume segment; deforming, with the computer, the isomorphic triangulation of the first horizon of the volume segment to fit a boundary of the second horizon of the volume segment; after the deforming, creating, with the computer, a template grid from the first horizon of the volume segment and the second horizon of the volume segment; generating, with the computer, layer sections from the template grid by cutting the template grid by lateral surfaces of the volume segment; and generating, with the computer, the volumetric data structure of the subsurface reservoir as a prismatic grid from isomorphic triangulations of the layer sections.

In the method, the obtaining the isomorphic triangulation of the first horizon can include creating isomorphic subdivisions of a skeleton edges of the first horizon.

In the method, the obtaining the isomorphic triangulation of the first horizon can include applying an advancing front triangulation to the first horizon.

In the method, the obtaining the isomorphic triangulation of the first horizon can include obtaining a constraint isomorphic triangulation.

In the method, the constraint can represent a terminating fault.

In the method, the creating the template grid can include providing a bounding box around the volume segment, generating a triangulation in an area between the first horizon boundary and a top boundary of bounding box and the second horizon boundary and a bottom boundary of the bounding box, and mapping top and bottom triangulations of the bounding box from two dimensions into three dimensional space.

In the method, the mapping can include mapping internal triangles using connections between the first and second horizon faces and their projections, and using a prolongation of the first and second horizon surfaces to map triangles between the first and second horizon surfaces and the top and bottom boundaries of the bounding box, respectively.

The method can further include modeling a subsurface reservoir using the prismatic grid generated from isomorphic triangulations of the layer sections.

The method can further include using the prismatic grid generated from isomorphic triangulations of the layer sections in a simulation of a subsurface reservoir.

The method can further include comprising using the prismatic grid generated from isomorphic triangulations of the layer sections in hydrocarbon management.

In the method, the generating layer sections can include obtaining contours from an intersection of layers of the template grid and a fault surface.

### BRIEF DESCRIPTION OF THE DRAWINGS

While the present disclosure is susceptible to various modifications and alternative forms, specific example embodiments thereof have been shown in the drawings and are herein described in detail. It should be understood, however, that the description herein of specific example embodiments is not intended to limit the disclosure to the particular forms disclosed herein, but on the contrary, this disclosure is to cover all modifications and equivalents as defined by the appended claims. It should also be understood that the drawings are not necessarily to scale, emphasis instead being placed upon clearly illustrating principles of exemplary embodiments of the present invention. Moreover, certain dimensions may be exaggerated to help visually convey such principles.

FIG. 1 is a flow chart of an exemplary method for generating a grid of a subsurface reservoir for modeling and/or simulation.

FIGS. 2A, 2B, 2C, 2D, and 2E illustrate an example of how to generate an isomorphic triangulation of top and bottom horizons.

FIGS. 3A, 3B, 3C, and 3D illustrate an example of how to construct a template grid in a bounding box.

FIGS. 4A, 4B, 4C and 4D illustrate an example of how to cut the template grid layers and produce layer sections of the volume segment.

FIGS. 5A, 5B, 5C, and 5D illustrate examples of final parameterization.

FIG. 6A, 6B, and 6C illustrate examples of final parameterization usage in modeling.

FIG. 7 is an exemplary computer system useable with the present technological advancement.

### DETAILED DESCRIPTION

Exemplary embodiments are described herein. However, to the extent that the following description is specific to a particular, this is intended to be for exemplary purposes only and simply provides a description of the exemplary embodiments. Accordingly, the invention is not limited to the specific embodiments described below, but rather, it includes all alternatives, modifications, and equivalents falling within the true spirit and scope of the appended claims.

The present technological advancement provides a methodology for creating a 3D parameterization in a volumetric domain with discontinuities. An exemplary application of the present technological advancement is the generation of a volumetric data structure or a grid of a subsurface reservoir for modeling and/or simulation, in which each domain is bounded by horizons and areal boundaries, and faults introduce discontinuities. The present technological advancement provides a more flexible approach than conventional technique in that the present technological advancement does not require parameterization be tied to a structured grid (pillar grid) or to a hex-dominant mesh. Rather, the parameterization in the present technological advancement is adaptive to the domain properties in terms of pillar distribution and shape. This provides higher accuracy in representing the original domain shape as well as improved quality of the resulting parameterization.

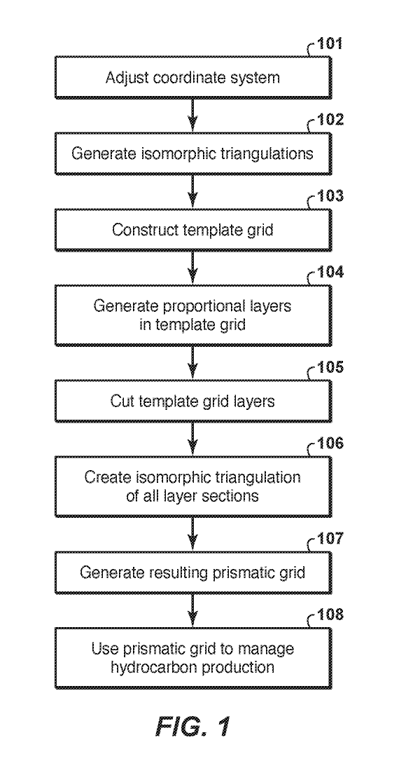

FIG. 1 is a flow chart of an exemplary method for generating a grid of a subsurface reservoir for modeling and/or simulation. This parameterization algorithm is developed for generation of prismatic grids in volume segments that are bounded by two horizon surfaces and by a few lateral surfaces formed by faults and boundaries of a geological model. If the faults do not cut through an entire model volume, the fault surfaces can be extended to the nearest intersection using known techniques, thus reducing the parameterization problem to one segment volume at a time. Alternatively, terminating faults can be treated as constraints on parameterization construction inside a segment.

A volume segment pillar gird is created as a result of isomorphic triangulation of a set of proportional layers inside a volume segment. Starting with a bottom horizon triangulation, it is deformed in a step by step manner to fit all layers. While the bottom horizon is used in this example, the top horizon could be used. Furthermore, the smaller of the bottom or top horizon could be used. To honor fault surfaces, singular points are placed at the fault-surface intersections, the same number of points for intersection of the fault with the top, bottom and intermediate layer surfaces, and these points from different surfaces are matched to each other along fault surface during fitting. Boundaries of the layers are subdivided simultaneously according to a predefined mesh density, preserving the singular points positions. Mesh density is computed based on the shape of the boundary in order to preserve all the features of the shape such as small edges or sharp angles accurately. The pillar built during the segment parameterization can be further used for geological layer construction (as a supporting data structure for simulation/modeling workflows) or used by itself as a simulation/modeling grid.

In step 101, the coordinate system is adjusted to the horizons of the volume segment. After adjustment, the coordinate system corresponds to the best fitted bounding box around the volume segment, thus it is more optimal computationally for representing this particular volume.

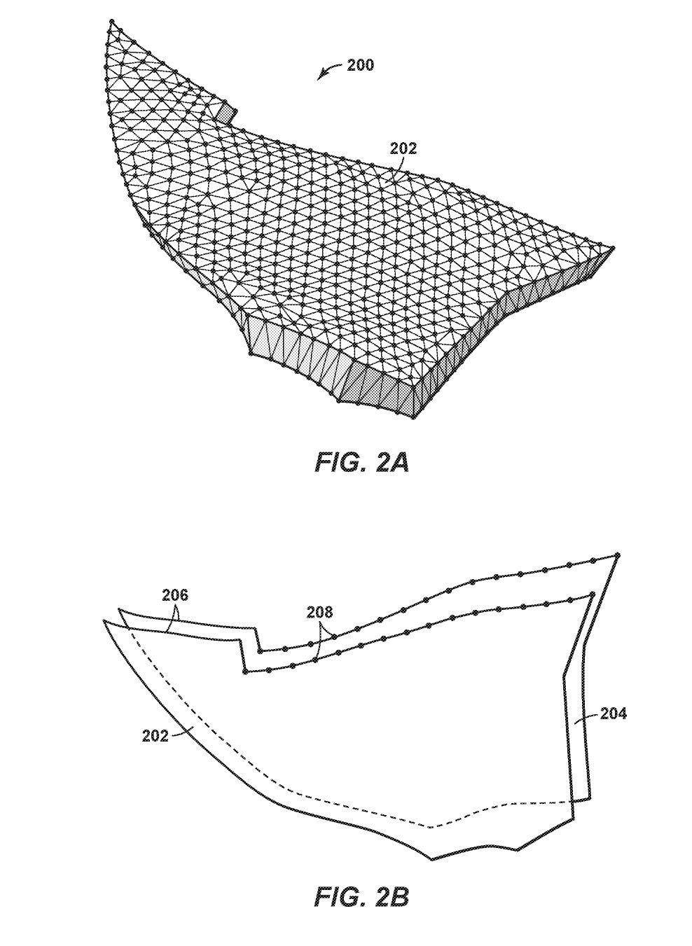

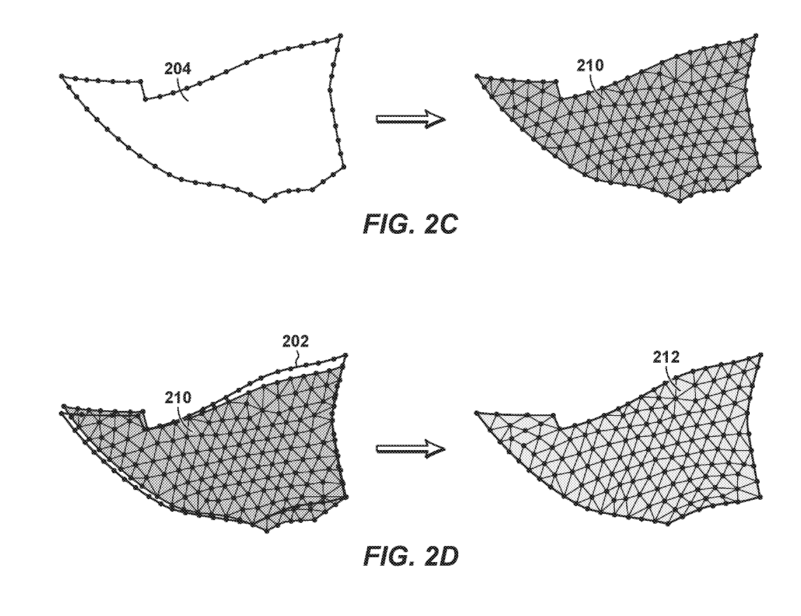

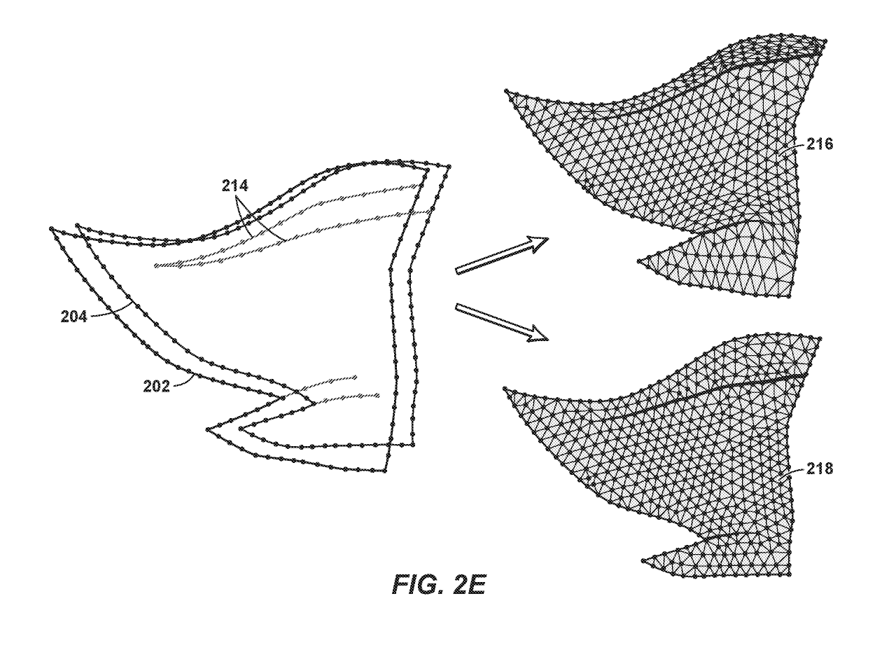

Step 102 includes generating isomorphic triangulation of the top and bottom horizons. FIGS. 2A-2E illustrates how step 102 can be implemented. FIG. 2A is a boundary grid of a volume segment 200. The corresponding edges of the top horizon 202 and bottom horizon 204 are obtained, and these skeletons have corresponding edges 206, as depicted in FIG. 2B. Isomorphic subdivisions 208 are created for the skeleton edges 206. Subdivisions are created for more accurate representation of the shape of the skeleton edges, the number of subdivisions is picked adaptive to the feature size of the shape (small edges or sharp angles require more subdivisions).

In FIG. 2C, triangulation is applied to the smaller bottom horizon 204, in order to generate bottom horizon triangulation 210. Triangulation refers to a net of triangles which partially or totally covers a surface or the procedure for generating the points and triangles of such a net of triangles. Conventional triangulation algorithms and software are known and a person of ordinary skill in the art can select an appropriate algorithm and software to create bottom horizon triangulation 210. For example, an advancing front triangulation algorithm, known to those of ordinary skill in the art, can be used to create bottom horizon triangulation 210.

In FIG. 2D, a grid deformation algorithm is used to move nodes of the resulting triangle grid 210 to fit the boundary of the top horizon 202. Any grid optimization or smoothing algorithm can be utilized here as long as it handles nonconvex domains, for example, a constrained version of Laplacian smoothing. This results in top horizon triangulation 212. Conventional grid deformation algorithms and software are known and a person of ordinary skill in the art can select an appropriate algorithm and software to create top horizon triangulation 212.

In FIG. 2E illustrates an example where horizons 204 and 202 include constraints 214, and the resulting constrained isomorphic triangulation of top horizon 216 and constrained isomorphic triangulation of bottom horizon 218. A constrain is a specification on the geometry or movement directions. For example, a constraint may correspond to a terminating fault.

Step 103 includes constructing a template grid in a bounding box. A template grid is a one layer prismatic grid in which top and bottom faces lie on the horizon surfaces of the volume segment or on a prolongation of these surfaces to the bounding box. The bounding box is a rectangular box that depicts the maximum and minimum XYZ extents of an object (e.g., surface). The creation of such a bounding box is well known to those of ordinary skill in the art, and is part of gOcad®.

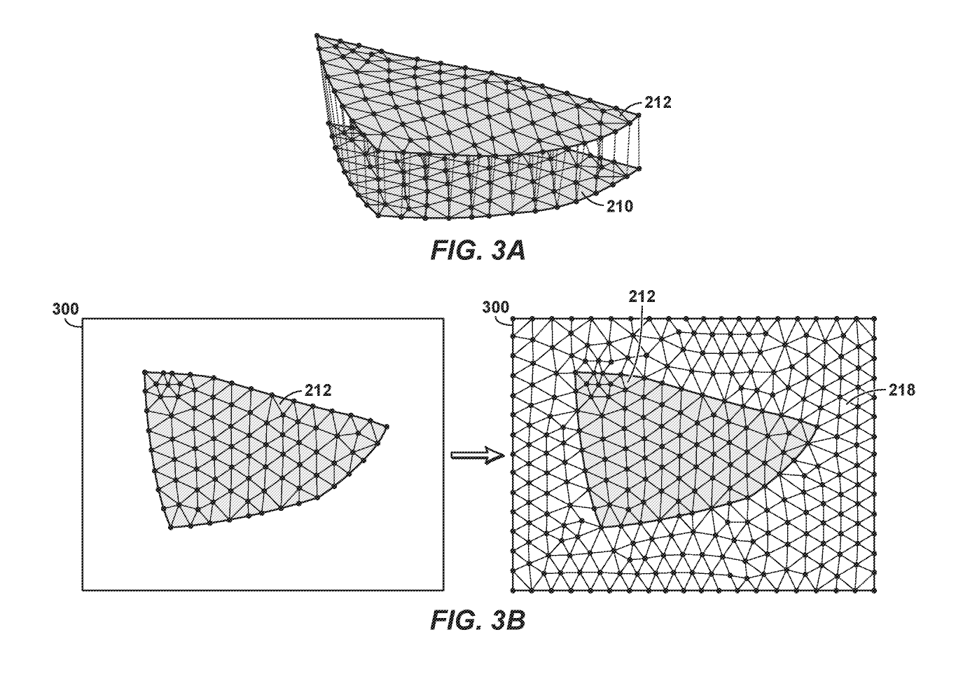

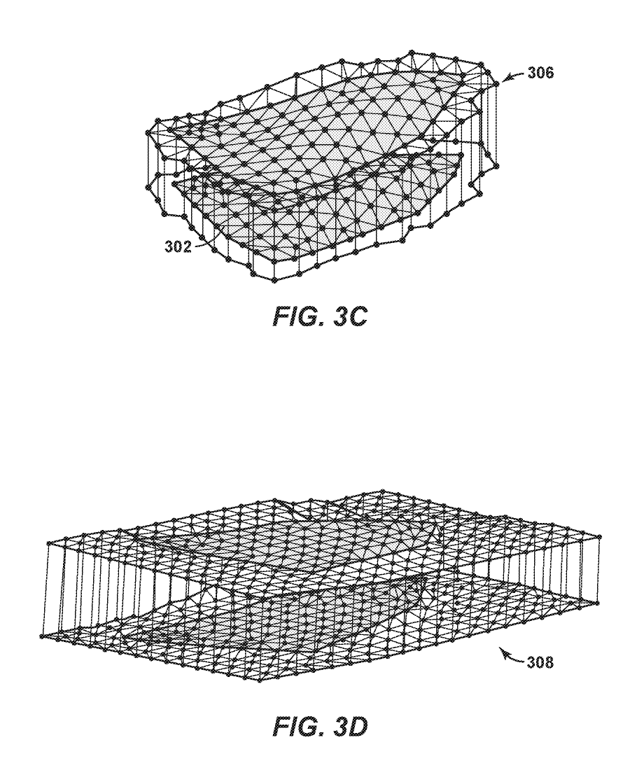

An example of step 103 is illustrated in FIGS. 3A-3D. FIG. 3A illustrates the triangulations of surfaces 210 and 212 from step 102. FIG. 3B illustrates surface 212 enclosed by bounding box 300 and the triangulation 218 of the area between the bounding box 300 and surface 212. While bounding box 300 is shown in 2D, this can be done in a 3D environment. FIG. 3C illustrates a mapping of the top and bottom triangulations 212 and 210 of the bounding box from 2D into 3D space. Internal triangles 302 are mapped using connections between horizon faces and their projections. Triangles between the horizon boundary and the bounding box 300 are mapped on a prolongation 306 of the initial horizon surface. FIG. 3D illustrates an example of the resulting template grid 308 in the bounding box of the volume segment.

Step 104 includes generating proportional layers between the top and bottom surfaces of the template grid. It can be done by subdividing template grid pillars (straight lines connecting vertices of top and bottom triangulations) into an equal number of intervals.

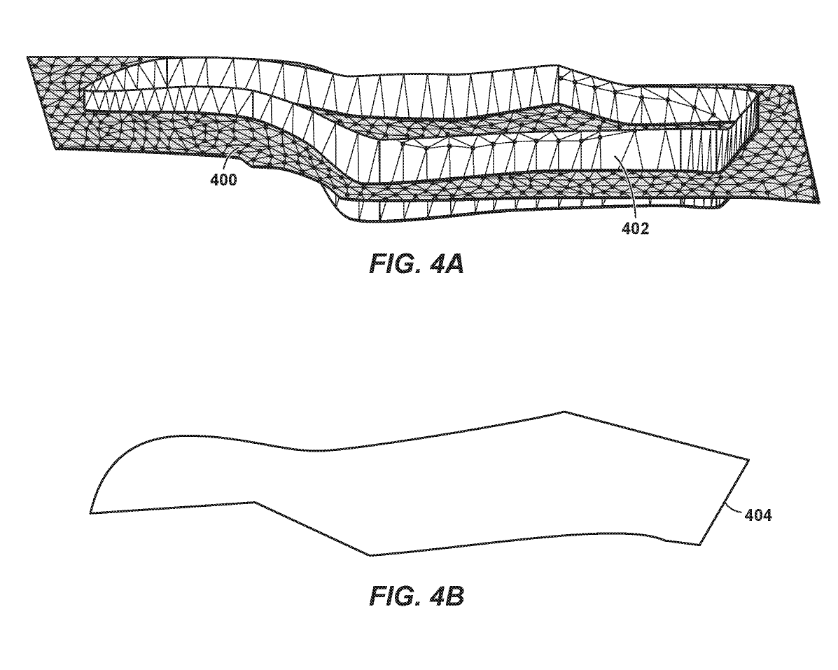

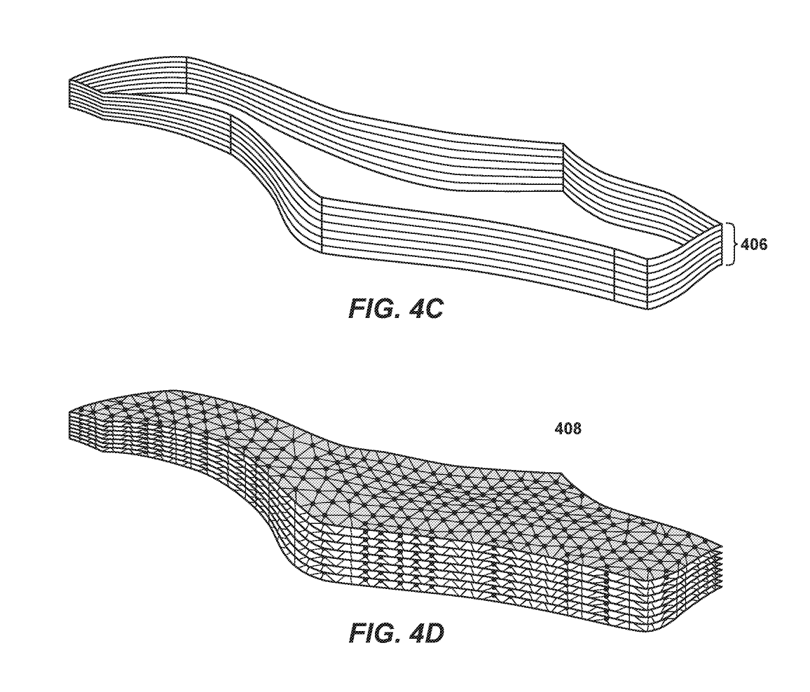

Step 105 includes cutting the template grid layers by the lateral surfaces of the volume segment, and producing layer sections of the volume segment. Cut by surface commands are well known in various CAD programs. An example of step 105 is illustrated in FIGS. 4A-4C. FIG. 4A illustrates an intersection of fault surfaces 402 with one lateral surface 400 of the template grid. FIG. 4B illustrates a resulting contour 404 from the intersection in FIG. 4A. FIG. 4C illustrates contours 406 after the intersection of fault surfaces will all layers of the template grid.

Step 106 includes creating isomorphic triangulation of all of the layer sections.

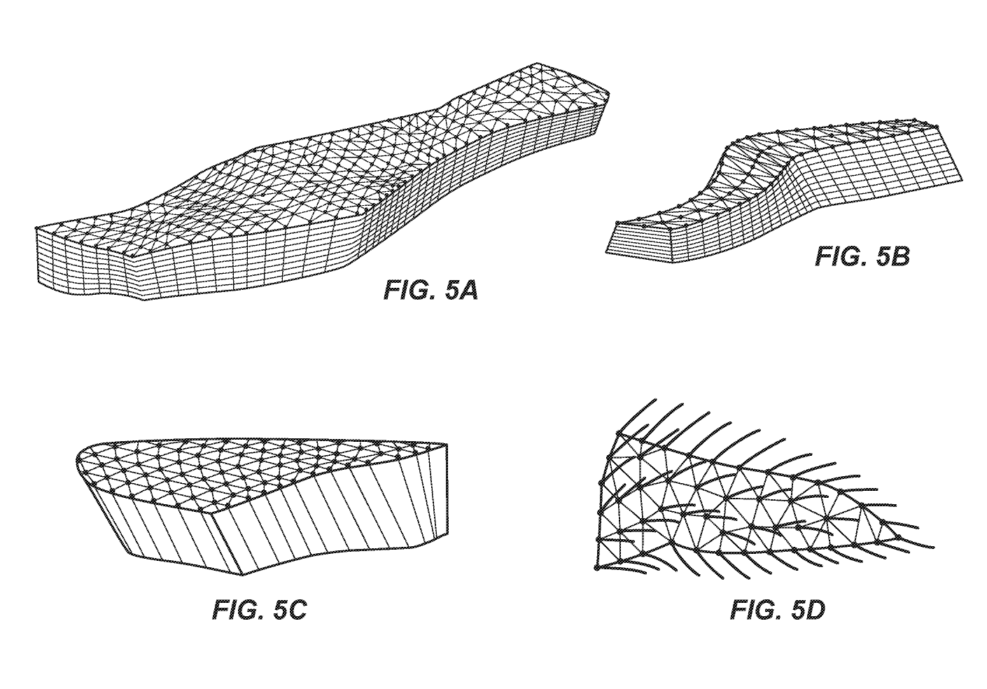

Step 107 includes generating the resulting prismatic grid based on the isomorphic triangle grids of the layer sections. FIG. 5 illustrates isomorphic triangulation of the surface areas 408 inside the contours 406, and provides the layers of the final prismatic grid.

Step 108 includes using the final prismatic grid to model a subsurface region or in subsurface simulations. These models and simulations can be used for hydrocarbon management. As used herein, hydrocarbon management includes hydrocarbon extraction, hydrocarbon production, hydrocarbon exploration, identifying potential hydrocarbon resources, identifying well locations, determining well injection and/or extraction rates, identifying reservoir connectivity, acquiring, disposing of and/or abandoning hydrocarbon resources, reviewing prior hydrocarbon management decisions, and any other hydrocarbon-related acts or activities.

FIGS. 5A-D illustrate examples of the final parameterization. FIGS. 5A-C show different geometries of volume segments and their resulting adaptive parameterization. For example, FIG. 5B demonstrates accurate handling of very narrow shaped segment. FIG. 5D shows flexible polylines pillars that accurately describe vertical variation in volume shape.

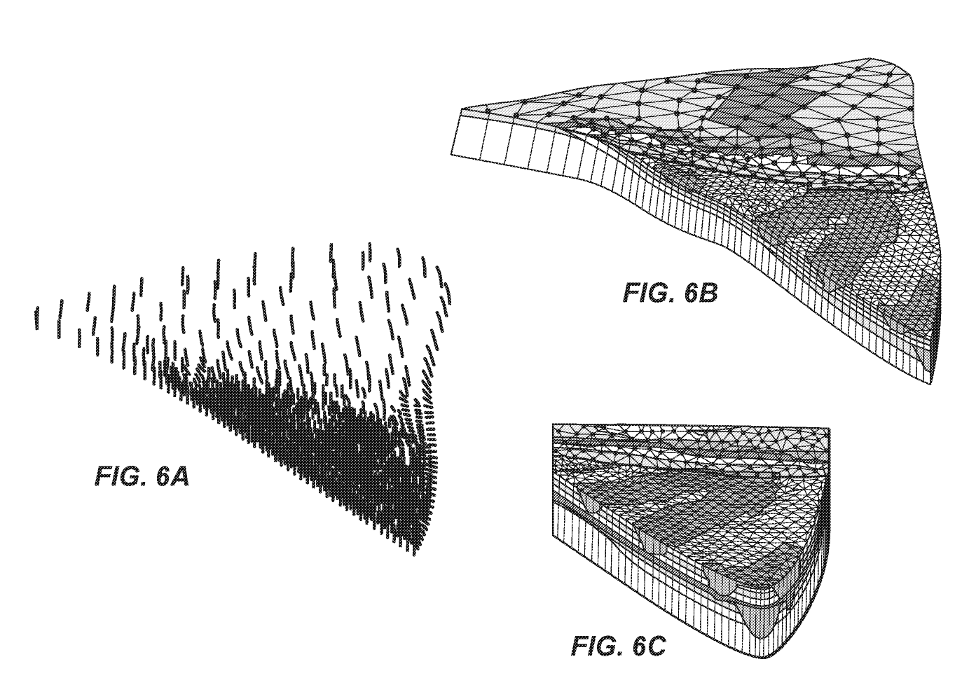

FIGS. 6A-C illustrate examples of the final parameterization used in modeling. FIG. 6A illustrates adaptive placement of pillars that allows better resolution of model features such as thin channels as shown in FIGS. 6B and C.

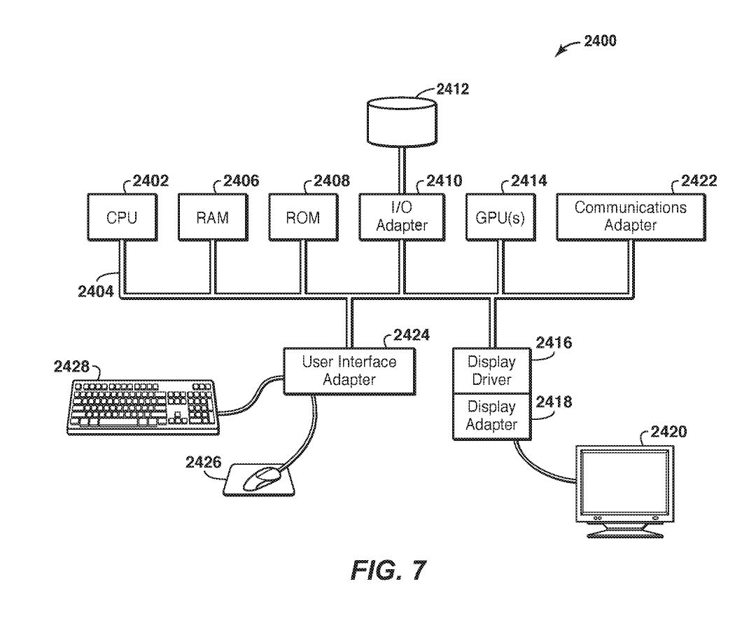

FIG. 7 is a block diagram of a computer system 2400 that can be used to execute the present techniques. A central processing unit (CPU) 2402 is coupled to system bus 2404. The CPU 2402 may be any general- purpose CPU, although other types of architectures of CPU 2402 (or other components of exemplary system 2400) may be used as long as CPU 2402 (and other components of system 2400) supports the operations as described herein. Those of ordinary skill in the art will appreciate that, while only a single CPU 2402 is shown in FIG. 7, additional CPUs may be present. Moreover, the computer system 2400 may comprise a networked, multi-processor computer system that may include a hybrid parallel CPU/GPU system. The CPU 2402 may execute the various logical instructions according to various teachings disclosed herein. For example, the CPU 2402 may execute machine-level instructions for performing processing according to the operational flow described.

The computer system 2400 may also include computer components such as nontransitory, computer-readable media. Examples of computer -readable media include a random access memory (RAM) 2406, which may be SRAM, DRAM, SDRAM, or the like. The computer system 2400 may also include additional non-transitory, computer-readable media such as a read-only memory (ROM) 2408, which may be PROM, EPROM, EEPROM, or the like. RAM 2406 and ROM 2408 hold user and system data and programs, as is known in the art. The computer system 2400 may also include an input/output (I/O) adapter 2410, a communications adapter 2422, a user interface adapter 2424, and a display adapter 2418.

The I/O adapter 2410 may connect additional non-transitory, computer-readable media such as a storage device(s) 2412, including, for example, a hard drive, a compact disc (CD) drive, a floppy disk drive, a tape drive, and the like to computer system 2400. The storage device(s) may be used when RAM 2406 is insufficient for the memory requirements associated with storing data for operations of the present techniques. The data storage of the computer system 2400 may be used for storing information and/or other data used or generated as disclosed herein. For example, storage device(s) 2412 may be used to store configuration information or additional plug-ins in accordance with the present techniques. Further, user interface adapter 2424 couples user input devices, such as a keyboard 2428, a pointing device 2426 and/or output devices to the computer system 2400. The display adapter 2418 is driven by the CPU 2402 to control, through a display driver 2416, the display on a display device 2420 to, for example, present information to the user regarding available plug-ins.

The architecture of system 2400 may be varied as desired. For example, any suitable processor-based device may be used, including without limitation personal computers, laptop computers, computer workstations, and multi-processor servers. Moreover, the present technological advancement may be implemented on application specific integrated circuits (ASICs) or very large scale integrated (VLSI) circuits. In fact, persons of ordinary skill in the art may use any number of suitable hardware structures capable of executing logical operations according to the present technological advancement. The term “processing circuit” encompasses a hardware processor (such as those found in the hardware devices noted above), ASICs, and VLSI circuits. Input data to the computer system 2400 may include various plug-ins and library files. Input data may additionally include configuration information.

The present techniques may be susceptible to various modifications and alternative forms, and the examples discussed above have been shown only by way of example. However, the present techniques are not intended to be limited to the particular examples disclosed herein. Indeed, the present techniques include all alternatives, modifications, and equivalents falling within the spirit and scope of the appended claims.

What is claimed is:

1. A method of generating a volumetric data structure of a subsurface region, comprising:
obtaining, with a computer, a volume segment of the subsurface region, wherein the volume segment is bounded by a first horizon and a second horizon, and by a plurality of lateral surfaces formed by faults and boundaries of a geological model corresponding to the subsurface region;
obtaining, with the computer, an isomorphic triangulation of the first horizon of the volume segment;
deforming, with the computer, the isomorphic triangulation of the first horizon of the volume segment to fit a boundary of the second horizon of the volume segment;
after the deforming, creating, with the computer, a template grid from the first horizon of the volume segment and the second horizon of the volume segment;
generating, with the computer, layer sections from the template grid by cutting the template grid by lateral surfaces of the volume segment; and
generating, with the computer, the volumetric data structure of the subsurface reservoir as a prismatic grid from isomorphic triangulations of the layer sections.

2. The method of claim 1, wherein the obtaining the isomorphic triangulation of the first horizon includes creating isomorphic subdivisions of a skeleton edges of the first horizon.

3. The method of claim 1, wherein the obtaining the isomorphic triangulation of the first horizon includes applying an advancing front triangulation to the first horizon.

4. The method of claim 1, wherein the obtaining the isomorphic triangulation of the first horizon includes obtaining a constraint isomorphic triangulation.

5. The method of claim 4, wherein the constraint represents a terminating fault.

6. The method of claim 1, wherein the creating the template grid includes providing a bounding box around the volume segment, and generating a triangulation in an area between the first horizon boundary and a top boundary of bounding box and the second horizon boundary and a bottom boundary of the bounding box, and mapping top and bottom triangulations of the bounding box from two dimensions into three dimensional space.

7. The method of claim 6, wherein the mapping includes mapping internal triangles using connections between the first and second horizon faces and their projections, and using a prolongation of the first and second horizon surfaces to map triangles between the first and second horizon surfaces and the top and bottom boundaries of the bounding box, respectively.

8. The method of claim 1, further comprising modeling a subsurface reservoir using the prismatic grid generated from isomorphic triangulations of the layer sections.

9. The method of claim 1, further comprising using the prismatic grid generated from isomorphic triangulations of the layer sections in a simulation of a subsurface reservoir.

10. The method of claim 1, further comprising using the prismatic grid generated from isomorphic triangulations of the layer sections in hydrocarbon management.

11. The method of claim 1, wherein the generating layer sections comprises obtaining contours from an intersection of layers of the template grid and a fault surface.
